(19) United States
(12) Patent Application Publication
(10) Pub. No.: US 2012/0174591 A1
(43) Pub. Date: Jul. 12, 2012

(54) Fuel Line System, Method for Operating of a Gas Turbine, and a Method for Purging the Fuel Line System of a Gas Turbine

(76) Inventors: Matthias Hase, Mulheim (DE); Axel Mayr, Berlin (DE); Jürgen Meisl, Mulheim an der Ruhr (DE)

(21) Appl. No.: 13/496,222

(22) PCT Filed: Sep. 23, 2010
(86) PCT No.: PCT/EP2010/064047

§ 371 Date: Mar. 15, 2012

(30) Foreign Application Priority Data
Sep. 24, 2009 (EP) 09012167.4

(51) Int. Cl. F02C 7/22

(52) U.S. Cl. 60/772; 60/734

(57) ABSTRACT

A fuel line system for a gas turbine and a method for purging the same is provided. Parts of the line system may be purged using a comparatively low quantity of purging medium. To this end, a control valve is provided in each of the fuel line segments located immediately upstream of the fuel injection nozzles, the control characteristics of the control valve being adjustable by means of a fluid or gaseous control medium

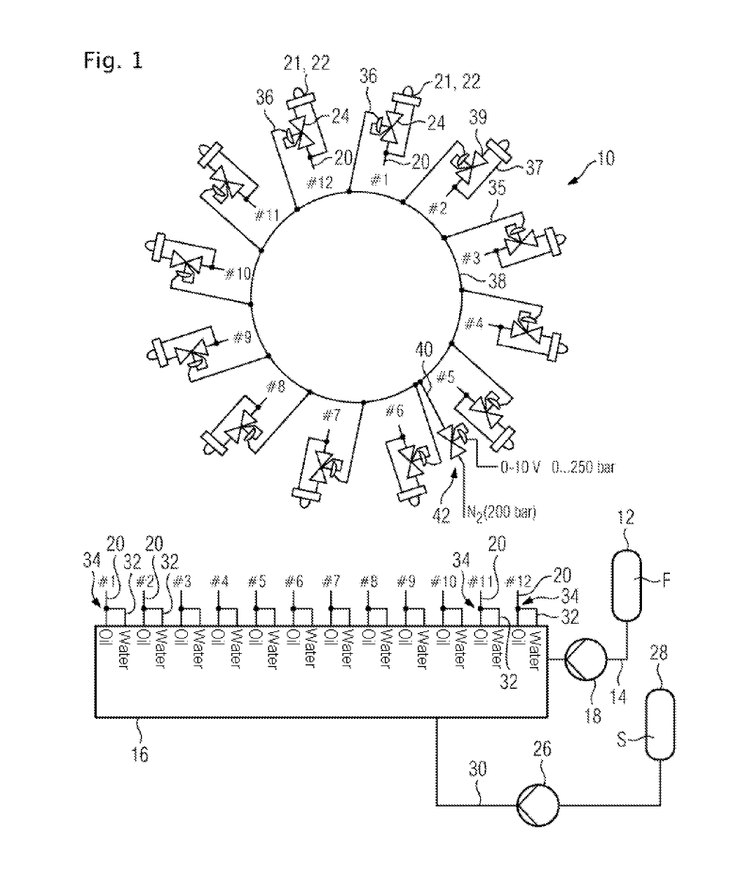

### CROSS REFERENCE TO RELATED APPLICATIONS

This application is the U.S. National Stage of International Application No. PCT/EP2010/064047, filed Sep. 23, 2010 and claims the benefit thereof. The International Application claims the benefits of European Patent Office application No. 09012167.4 EP filed Sep. 24, 2009. All of the applications are incorporated by reference herein in their entirety.

### FIELD OF INVENTION

The invention relates to a fuel line system for a gas turbine, to a method for operation of a gas turbine, and to a method for purging the fuel line system of a gas turbine.

### BACKGROUND OF INVENTION

As gas turbine auxiliary systems, fuel line systems connect a fuel tank or a fuel supply network to the burners of the gas turbine with the aid of a multiplicity of lines and line sections, in which various components are provided for cleaning the fuel, for measuring the characteristics of the fuel, for adjusting the pressure of the fuel and for adjusting the amount of fuel required during operation of the gas turbine.

By way of example, one such fuel line system is disclosed in U.S. Pat. No. 4,817,389. The gas turbine disclosed therein has a multiplicity of fuel nozzles, which are distributed on a circle, for injection of fuel into the gas turbine combustion chamber. The plurality of fuel nozzles are main burners. Two of the fuel nozzles are pilot burners, which are arranged in an area lower than the main burners. One supply line with a fuel pump connects the fuel tank to a fuel control system. From there, the supply line extends further to a pressure control valve, which supplies the fuel by means of two outputs to the burners, via further fuel lines and fuel distributors. The fuel control system adjusts the fuel flow to the burners. Normally, a minimum flow is set to the main burners, and the fuel flow to the pilot burners is slightly modulated.

In order to prevent hot-gas streaks of different temperature in the combustion chamber, and therefore to ensure a uniform temperature in the hot gas along the circumference, U.S. Pat. No. 4,817,389 proposes that a pressure control valve be provided in the lines which lead to the main burners. Particularly when starting up the gas turbine and in the event of a rapid reduction in rotation speed, the pressure control valve redistributes the fuel mass flow between the individual burner groups in an advantageous manner, preventing a non-uniform temperature distribution in the combustion chamber. This has the disadvantage that the configuration in this case relates to a multiplicity of main burners, which are provided above the pilot burners, which are arranged in the annular combustion chamber.

It therefore appears that this can be used only with difficulty in gas turbines with a different burner or combustion chamber configuration.

In addition, EP 1 199 454 A2 discloses a dual-fuel fuel system for a gas turbine, in which the fuel supplied to the burners can be adjusted with the aid of control valves. Furthermore, DE 10 2008 044447 A1 discloses the control valves of a fuel supply system for a gas turbine being operated selectively in order to achieve reliable combustion, with low emissions. Fuel supply systems such as these are, however, comparatively complex.

The use of pilot and main burners is disclosed, for example, in EP 1 475 569 A1, in which case these can be operated in different groups via appropriate control valves. Furthermore, U.S. Pat. No. 5,881,550 discloses a purging method for a fuel supply system for a gas turbine.

Furthermore, pilot burners operated with oil fuel are known in gas turbines. At least one passive control element is provided for the relevant pilot stage, for example a spring-controlled non-return valve to prevent reverse flow. It is also known for an actively controlled control valve to be used instead of the non-return valve, in order to additionally make it possible to adjust the fuel mass flow. In general, however, an actively controlled second stage is associated with high costs for the additional pipeline and control system, while the passive control element lacks the flexibility during gas turbine operation.

Furthermore, when using a non-return valve in the fuel line system, the purging water which, after gas turbine operation, displaces the oil which is present in the burners and the connecting lines thereof, must overcome the back-pressure of the non-return valve immediately upstream of the burner, in order to ensure that the purging water actually also removes oil residues from the burners. Particularly in the case of low combustion chamber pressures, this leads to high purging water mass flows occurring, which shorten the life of the components located downstream of the burner, such as the combustion chamber wall and turbine blades.

### SUMMARY OF THE INVENTION

The invention is therefore based on the object of specifying a fuel line system for a gas turbine and a method for purging the same, which allows the line system to be purged with a comparatively small amount of purging medium. A further object is to specify a gas turbine whose components arranged downstream from the burner have a longer life, by virtue of the purging of the burner and of the fuel line associated with it or them.

The object relating to the fuel line system is achieved by a system according to the features of the claims. The object relating to the gas turbine is achieved by a gas turbine which is designed according to the features of the claims. Furthermore, the object relating to the method for purging a fuel line system is achieved by the features of the claims.

All the solutions have the common feature that a control valve with a variable control characteristic is arranged in at least one fuel line which passes fuel on from the distributor or from a plurality of distributors to a number of injection nozzles. The solution is based on the discovery that the passive control element, which was previously in the form of a non-return valve, can be provided by means of further elements with the capability to allow matching of the control response. In this case, the matching can be carried out during gas turbine operation, which means while fuel is being burnt in the gas turbine, or else after this. As a further element for matching of the control response, a further connection is preferably provided for the passive control element, via which the control characteristic of the control valve can be matched or adjusted. A control line is connected to the connection, via which a gaseous or liquid control medium can be supplied to the control valve in order to influence the control characteristic. In this case, the pressure of the control medium can be matched during gas turbine operation or after operation, thus allowing the control characteristic of the control valve to be adjusted. Such matching is preferably worthwhile during or shortly before purging. During operation of the gas turbine, the back-pressure in the control medium which is present at the control valve is comparatively fairly high.

The use of the control valve according to the invention in a fuel line system for a gas turbine allows the fuel to be transferred to the injection nozzles at different fuel supply pressures by matching the back-pressure in the control valves. The system can preferably also be used for burners which are designed for operation with liquid fuel and with more than one or two pilot stages. In general, the system can be used for multi-stage burners, irrespective of whether they are operated using gas or oil.

The adjustment of the control characteristic during operation of the gas turbine as a function of the gas turbine power allows the fuel to be distributed optimally into the appropriate combustion zones for the instantaneous load to be provided by the gas turbine. This method is particularly advantageous for an injection nozzle which is in the form of an oil pilot nozzle and has two swirl chambers, which inject the fuel into the gas turbine combustion chamber at different points. This process may also be advantageous for an oil pilot nozzle having only one swirl chamber.

The apparatus according to the invention also allows the load on the control valve with a variable control characteristic to be removed completely for a purging process for the corresponding fuel line, and for the injection nozzle connected thereto downstream. After the relevant burner line has been disconnected the back-pressure in the control medium is reduced to a comparatively low value, or even to zero, for the purging process. In consequence, it is sufficient to use a supply pressure which is lower—in comparison to previous purging methods—but is slightly higher—with respect to the back-pressure—in the purging medium, in order to open the control valve with the variable control characteristic, in order to purge the line and the injection nozzle. This makes it possible to carry out purging with a comparatively low purging medium mass flow.

In other words, the fuel line system according to the invention now allows a purging method in which, after the fuel feed has been switched off by the fuel line system of the appropriate burner stage, the purging medium is fed from a purging medium source via a purging medium feed line, which opens into the relevant fuel line, to the injection nozzles at a comparatively low supply pressure, and in which the control valve is adjusted with the aid of a back-pressure, which is lower with respect to the purging medium supply pressure, in the control medium, such that this control valve is opened when the supply pressure at the control valve input is comparatively low. In consequence, the relatively high purging medium mass flow which was previously used in the prior art can therefore be reduced while the purging performance remains the same, reducing the load caused by the purging medium on the components downstream from the injection nozzle and the burner. Since less purging medium is injected into the combustion chamber and into the turbine, these components are subjected to a reduced thermal shock load after the fuel feed has been switched off. This lengthens the life of the relevant components.

Furthermore the control valve is in the form of a conventional non-return valve with an input connection and an output connection which, instead of or in addition to the spring of the non-return valve, has a control connection for the control medium, to which a back-pressure, to be overcome by the input pressure, can be applied in order to open the control valve. Dependent on the magnitude of the back-pressure, the control valve either opens when the pressure at the input connection of the control valve is greater than the opposing force provided by the spring of the non-return valve, provided that a spring is present, or the control valve opens only when the pressure at the input connection overcomes a back-pressure in the control medium. A back-pressure and a spring force preferably have to be overcome at the same time.

For symmetry reasons, a plurality of control valves are arranged in the fuel line system of a gas turbine, whose control line is tapped off from a common control supply line, for simultaneous operation. In this case, a further control valve is provided in the control supply line, in order to adjust the pressure in the control medium. The injection nozzles may in this case be in the foim of at least one burner stage in one or more burners.

### BRIEF DESCRIPTION OF THE DRAWINGS

The invention will be explained further with reference to the exemplary embodiment illustrated in the drawing. The single FIGURE shows a control system for a two-stage pilot oil nozzle in a gas turbine.

### DETAILED DESCRIPTION OF INVENTION

The single FIGURE schematically shows a fuel line system 10 for a gas turbine. The fuel line system 10 is connected on the feed side to a fuel source 12, which may, for example, be in the form of a tank, and has a fuel supply line 14, which connects the fuel source 12 to a distributor 16. A pump 18 for feeding liquid or gaseous fuel F is likewise provided in the supply line 14. A multiplicity of fuel lines 20 are tapped off from the distributor 16 and end—as will be explained in detail further below—at injection nozzles 21 in the gas turbine. In this case, the injection nozzles 21 are in each case parts of a conventional gas turbine burner 22. The burners 22 may have at least one stage, for example a pilot stage or a main stage. It is likewise possible for the burners 22 to have both pilot stages and main stages. Furthermore, in this case, it is possible for the burners 22 to have at least one pilot stage or at least one main stage, which each have at least two injection nozzles 21 and two swirl chambers, as a result of which both the pilot nozzle and the main nozzle may be referred to as being multistage devices.

In the illustrated exemplary embodiment, a total of twelve burners 22 are provided for the gas turbine. Twelve fuel lines 20 are therefore also tapped off from the distributor 16, and individually connect the distributor 16 to the twelve injection nozzles 21. However, the individual connections are not shown in the form of lines, for clarity reasons, but are linked only logically here via association numbers #1 to #12: the fuel lines 20, nos. #1 to #12 which are tapped off from the distributor 16 are each individually connected to the fuel lines 20, as described further above, with corresponding numbering.

Furthermore, the distributor 16 can be supplied via a purging medium supply line 30 and with the aid of a further pump 26, which is provided therein, with a purging medium S, for example water, from a purging medium source 28. It is, of course, also possible to provide a further distributor, separate from the distributor 16, for this purpose. Furthermore, the distributor 16 has 12 purging medium outputs 32. These each open at a feed point 34 in one of the fuel lines 20.

The illustrated burners 22 are, for example, pilot burners, which have two stages and therefore, in detail, are equipped with two fuel inputs 37, 39. One (37) of the two fuel inputs 37, 39 of the burners 22 is connected directly to the distributor 16, that is to say without the interposition of a control valve 24 with a variable control characteristic, while in contrast the other (39) of the two fuel inputs 37, 39 of the burners 22 is connected to the distributor 16 via a control valve 24 according to the invention.

All of the control valves 24 which are arranged in the fuel lines 20 each have a control connection 36, which is connected to a ring line 38 via a control line 35. The ring line 38 is connected via a control supply line 40 to a control medium source, which is not illustrated. A further control valve 42 is provided in the control supply line 40, by means of which the pressure in the ring line 38, and therefore at the control connections 36 of the respective control valves 24, with a variable control characteristic, can be adjusted.

By way of example, nitrogen or some other suitable gaseous or liquid control medium may be provided as the control medium. A back-pressure in the control valves 24 can be set via the control supply line 40 and the ring line 38 during operation of the gas turbine, as well as thereafter, for the purging process. This makes it possible to vary the control characteristic of the control valves 24. The adjustment of the back-pressure in the control valves 24 also includes the reduction to the ambient pressure, which allows the control valve 24 to be opened even when the supply pressures in the fuel line 20 are very low. This is preferably done after the relevant fuel feed has been switched off, in order to remove fuel from the fuel lines 20 with the aid of the purging medium, thus preventing the fuel lines 20 from becoming coked up.

A minimum amount of fuel can be injected into the combustion chamber via the fuel inputs 37 which are connected directly to the fuel lines 20. During operation of the gas turbine, the amount of fuel supplied via the fuel inputs 39 which are in parallel therewith can be increased by reducing the back-pressure in the control medium to a level below the fuel pressure which is applied to the input side of the control valve 24, and this can have a positive influence on the combustion.

Overall, the invention specifies a fuel line system 10 for a gas turbine and a method for purging the same, which allows purging of parts of the line system 10 with a comparatively small amount of purging medium S. For this purpose, a control valve 24 is provided in each of the fuel line sections 20 which are present directly upstream of the fuel injection nozzles 21, the control characteristic of which control valve 24 can be adjusted with the aid of a fluid control medium.

The numerical values in the figure are parameters which are used only by preference.

1-7. (canceled)

8. A fuel line system for a gas turbine, comprising:
a fuel supply line for supplying and feeding liquid or gaseous fuel from a fuel source to a distributor; and
a plurality of fuel lines for passing on fuel from the distributor or from a plurality of distributors to a plurality of injection nozzles, by means of which the fuel may be injected into a combustion chamber of the gas turbine,
wherein a control valve with a variable control characteristic is arranged in at least one fuel line,
wherein the control characteristic of the relevant control valve may be adjusted by means of a gaseous or liquid control medium which is supplied via a control line, and
wherein the control valve is designed in the form of a non-return valve with an input connection and an output connection which, instead of or in addition to the spring of the non-return valve, has a control connection for the control medium, to which a back-pressure, to be overcome by the input pressure, is applied in order to open the control valve.

9. The fuel line system as claimed in claim 8, wherein the plurality of relevant control valves, each include a control line which is tapped off from a common control supply line.

10. The fuel line system as claimed in claim 9, wherein a further control valve is provided in the control supply line, in order to adjust the pressure in the control medium.

11. A gas turbine, comprising:
a fuel line system as claimed in claim 8,
wherein at least one of the injection nozzles is in the form of a burner stage in a burner.

12. The gas turbine as claimed in claim 11,
further comprising a plurality of burners, which, as injection nozzles, each have at least one first pilot stage and one second pilot stage, with all of the injection nozzles which can be associated with the first pilot stage being connected to the fuel line system, and with all of the injection nozzles which are associated with the second pilot stage directly connected to the distributor.

13. The gas turbine as claimed in claim 11, wherein the plurality of relevant control valves, each include a control line which is tapped off from a common control supply line.

14. The gas turbine as claimed in claim 13, wherein a further control valve is provided in the control supply line, in order to adjust the pressure in the control medium.

15. A method for operation of a gas turbine, comprising:
providing a fuel line system as claimed in claim 8,
wherein a relevant control valve is adjusted as a function of the gas turbine power.

16. A method for purging the fuel line system as claimed in claim 8, comprising:
switching off the fuel feed; and
feeding through a purging medium the relevant sections of the fuel line system from a purging medium source via a purging medium output, which opens into the relevant fuel line, to the injection nozzles at a comparatively low supply pressure, in that a control medium back-pressure, which varies the control characteristic of the control valve, is reduced to such an extent that the control valve opens.
